(19) United States
(12) Patent Application Publication
(10) Pub. No.: US 2023/0038333 A1
(43) Pub. Date: Feb. 9, 2023

(54) METHODS FOR CREATING RAPIDLY CHANGING ASYMMETRIC ELECTRON SURFACE DENSITIES FOR ACCELERATION WITHOUT MASS EJECTION

(71) Applicant: Glen A. Robertson, Madison, AL (US)

(72) Inventor: Glen A. Robertson, Madison, AL (US)

(21) Appl. No.: 17/396,714

(22) Filed: Aug. 8, 2021

(51) Int. Cl. H05H 15/00

(52) U.S. Cl. CPC H05H 15/00

(57) ABSTRACT

A method for creating rapidly changing asymmetric electron surface densities that change fast enough to produce time dilation and retardation between the density of an accelerated mass and the rapidly changing electron densities on the surface of the accelerated mass; for acceleration without mass ejection under a new quantum gravity model. The method includes, an accelerated mass, a pulse electric discharge system, an electron reversal means, and a controller.

### BACKGROUND

The present invention relates to a method for creating rapidly changing asymmetric electron surface densities for acceleration without mass ejection based on a new quantum gravity model, derived from a historical standpoint, that there is considerable theoretical and experimental basis behind the idea that everything that surrounds us can be described as a macroscopic collection of fluctuations, vibrations, and oscillations associated with quantum mechanical fluctuations and quantum energy fluctuations. Whereby, all objects are composed of quantum mechanical fluctuations—super-imposed on quantum energy fluctuations and surrounded by a medium of quantum energy fluctuations. Whereby, the combined quantum mechanical and energy fluctuations in objects and the quantum energy fluctuations in the external quantum energy field surrounding objects are two separate quantum energy fields. As such, the combined quantum mechanical and energy fluctuations in objects produces a thin energy shell of quantum fluctuations (ESQFs), emanating from the surface of objects, that is entangled to the internal and external quantum energy fields to mediate differences that occur between the internal and external quantum energy fields.

The new quantum gravity model is partially discussed herein as taken from the online peer reviewed paper by the inventor entitled “Quantum Gravity as a Quantum Warp Field,” on Research Gate, the General Science Journal, and LinkedIn websites, wherein ESQFs can be evaluated at every radial distance from an objects, bestowing features like spacetime within general relativity, whereby asymmetric changes in the ESQFs about accelerated objects behave like a warp field (expanding and contracting the external quantum field about the object) to produce acceleration—gravitationally or by other acceleration means. Specifically like the warp field as presented in the 1994 paper by M. Alcubierre, entitled “The warp drive: hyper-fast travel within general relativity,” Class. [symbol] uant. Grav. 11, pg. L73-L77.

The “quantum energy” in this new quantum gravity model is not “vacuum energy” as discussed in literature. Specifically as in “vacuum energy” acceleration models, electromagnetic (EM) methods are used to create acceleration by acting on the EM field composing “vacuum energy.” Wherein, the new gravity model, the “quantum energy field” is not an EM field but spacetime. As such, in the new quantum gravity model acceleration comes from changing the density distribution of the “mass” in the ESQFs. However, electric and magnetic fields can be used to change the density distribution of charged masses in the ESQFs. One such method is the present invention.

Further, the ESQFs about all objects is the same thin-shell about all objects as discussed in the 2004 paper by J. Khoury, and A Weltman, entitled “Chameleon Cosmology,” Phys. Rev. D, 69, p. 044026, (2004), which is a new gravity model based on the density environment about object, wherein the thin shell has an outer radius R̅ a bit greater than the radius R of the object and where the difference ΔR=R̅−R is the thin-shell thickness. In general, the new quantum gravity model converts “Chameleon Cosmology” into an acceleration model where changing the density distribution of the “mass” in the ESQFs creates acceleration—gravitationally and by other acceleration means.

Under the new quantum model, the thin shell's thickness ΔR under “Chameleon Cosmology” was shown to be the wavelength λ of the quantum energy in the ESQFs (thin shell), where the quantum energy in the ESQFs about an objects, in the plane of motion (forward to aft-ward), behave much like two opposing Casimir cavities with the object being centered between them and free to move. Whereby, when the quantum energy in the two opposing Casimir cavities are asymmetric, i.e., the quantum energy in one Casimir cavity (aft-ward ESQFs) is higher than the quantum energy in the other Casimir cavity (forward ESQFs), the object accelerates forward, with the reverse true.

In earlier versions of the new quantum gravity model, for example, the peer reviewed paper by the inventor entitled “The Chameleon Solid Rocket Propulsion Model,” AIP CP1208, SPESIF, (2010) and the follow on paper entitled “Propulsion Physics under the Changing Density Field Model,” presented at JANNAF (2012), it was shown that this model could be used to predict the thrust from a simple solid rocket motor.

In another earlier version of the new quantum gravity model, in the peer reviewed paper by the inventor and M. J. Pinheiro entitled “Vortex Formation in the wake of Dark Matter Propulsion,” Physics Procedia, Volume 20, Elsevier Science, (2011), similarities of the earlier version of the new quantum model to conventional and non-conventional propulsion is discussed.

In accordance to the new quantum gravity model, the acceleration of a mass r is due to the asymmetric change in the unaccelerated wavelength λᵣ=ΔRᵣ in the mass's ESQFs, producing a forward (FWD) ESQFs quantum wavelength (λᵣ)_{FWD} that is different from the aft-ward (AFT) ESQFs quantum wavelength (λᵣ)_{AFT} as defined by the direction of motion being forward. Whereby, the acceleration aᵣ of the mass can be given in relationship to these wavelengths, (λᵣ)_{FWD} and (λᵣ)_{AFT} , according to

aᵣ≈(4π/3)((λᵣ)_{AFT}⁻⁴−(λᵣ)_{FWD}⁻⁴) [symbol] _{λ}R_{g}, (Equation 1)

where R_{g} is the radius of the dominate local gravitational mass,

[symbol]

_{λ}=(4π²ℏ/c)G≈9.268×10⁵² m⁴/s² (Equation 2)

is a constant that is directly related to the Newtonian constant of gravitation. The radius R_{g} of the local dominate gravitational mass is important as it establishes the local external quantum field Φ_{g} that the mass is accelerated in.

The forward and aft-ward wavelengths, (λᵣ)_{FWD} and (λᵣ)_{AFT}, are defined with respect to the change in the density distribution within the mass's ESQFs by,

(λᵣ)_{AFT}≈[(4π²ℏ/c)ρ_{AFT}⁻¹]^{(1/4)}

(λᵣ)_{FWD}≈[(4π²ℏ/c)ρ_{FWD}⁻¹]^{(1/4)} (Equation 3)

where ρ_{AFT} is the aft-ward (AFT) density distribution and ρ_{FWD} is the forward (FWD) density distribution within the mass's ESQFs; about the ESQFs radius R̅, such that when ρ_{AFT}>ρ_{FWD}, (λᵣ)_{FWD}>(λᵣ)_{AFT} with the reverse true. Given (λᵣ)_{FWD}>(λᵣ)_{AFT}, the mass is accelerated forward, per Equation 1. In like to opposing Casimir cavities, the quantum energy (Eᵣ)_{FWD}≈hc/(λᵣ)_{FWD} in the forward ESQFs is less than the quantum energy (Eᵣ)_{AFT}≈hc/(λᵣ)_{AFT} in the aft-ward ESQFs. Whereby, the associate quantum energy pressures are unbalanced, causing the mass to accelerate, in the direction away from the higher quantum energy in the aft-ward ESQFs.

Combining Equations 1-3 yields the accelerated mass's acceleration as

aᵣ≈(4π/3)[(ρᵣ)_{AFT}−(ρ_{c})_{FWD}]GR_{g}; (Equation 4)

noting that the factor 4π/3 is a geometric factor associated with spherical objects.

Under the present invention, the accelerated mass's outer surface is composed of an electrically conductive material. The accelerated mass's shape is asymmetric to produce an asymmetric surface area in the plane of motion (FWD to AFT) that is subjected to a voltage charge from a pulse electric discharge system to either rapidly increase or decrease the number of electrons on the outer surface of the accelerated mass. Whereby the asymmetric surface area in the plane of motion (FWD to AFT) produces the asymmetric (increase or decrease) electron densities (ρₑ)_{FWD} and (ρₑ)_{AFT} to produce acceleration on the accelerated mass.

In similarity to rapidly changing electrons that produce electric and magnetic fields that are time varying to produce time dilation and retardation under Lienard-Wiechert potentials, under this new quantum gravity model there are overlapping quantum fields; the quantum field in the accelerated mass and the quantum field in the ESQFs about the accelerated mass. As such, there is a density retardation mediated by the elemental particles emitted into the ESQFs from the rapidly changing electron density increase or decrease on the surface of the accelerated mass. That is, a small reaction time Δt=ΔR̅ᵣ/c=Δλᵣ/c is induced between the accelerated mass's density and the rapidly changing electron density on the surface of the accelerated mass, corresponding to a change ΔR̅ᵣ=Δλᵣ to the accelerated mass's ESQFs outer radius with a phase shift ωΔt from the normal ESQFS outer radius R̅ᵣ of the accelerated mass. This infers a retardation time t′=t−Δt, which results in the density of the rapidly changing electrons on the surface of the accelerated mass dominating during the discharge in the overlapping time dilated quantum energy fields. Whereby, it is only the rapidly changing and asymmetric FWD and AFT electron densities (ρₑ)_{FWD} and (ρₑ)_{AFT} on the surface of the accelerated mass that causes acceleration, with reference to Equation 4.

The FWD and AFT electron densities are

(ρₑ)_{FWD}≈κ_{FWD}(±N·mₑ/S_{FWD}·dₑ)

(ρₑ)_{AFT}≈κ_{AFT}(±N·mₑ/S_{AFT}·dₑ) (Equation 5)

where N is the number of electrons, mₑ is the electron mass, dₑ is the average thickness of the electrons on the surface of the accelerated mass, and where the ± sign indicates whether the electrons are added (+) (increased) or removed (−) (decreased). Noting that the number of electrons N (added or removed) is related to the ± voltage potential applied and the material composition of the surface of the accelerated mass. In Equation 5, the factors κ_{FWD}≤1 is the FWD surface area correction factor and κ_{AFT}≤1 is the AFT surface area correction factor, which correspond to the differences in the FWD and AFT surface areas of the accelerated mass, as the two surface areas are not completely perpendicular to the plane of motion (FWD to AFT). Then by letting the AFT surface area be larger than the FWD surface area, a surface area factor η≈S_{AFT}/S_{FWD}≥1 can be defined, which when combined with Equation 5 yields

(ρₑ)_{AFT}≈κ_{AFT}/η(ρₑ)_{FWD}. (Equation 6)

Such that using the form of Equation 4, the acceleration on the accelerated mass is given as

aᵣ≈[(ρₑ)_{AFT}−(ρₑ)_{FWD} ]GR_{g}≈−κ(±N·mₑ / S_{FWD}·dₑ)GR_{g}, (Equation 7)

where κ=[1−κ_{AFT}/ηκ_{FWD}] is the geometric factor for the present invention, which allows the factor 4π/3 to be dropped as it is the geometric factor related to the spherical shape of the objects used to develop the new quantum model.

The acceleration Equation 7 does not take into consideration other factors as the external atmosphere, internal material composition of the accelerated mass, and etc. Whereby, other correction factors may arise when testing the present invention.

The acceleration on the accelerated mass is an impulse. Therefore, the time-averaged acceleration on the accelerated mass is a function of the time rate of change tₜ of the added (+N) or increasing (I) electron density on the surface of the accelerated mass or the time rate of change t_{D} of the removed (−N) or decreasing (D) electron density on the surface of the accelerated mass, and the frequency f of occurrence. Therefore using Equation 7, the increasing (I) and decreasing (D) time-averaged accelerations of the accelerated mass are rewritten as

$${( {a}_{r} )}_{I} \approx - κ ( \frac{{N}_{I} {m}_{e}}{{S}_{FWD} {d}_{e}} ) G {R}_{g} \cdot {t}_{I} {f}_{I} {( {a}_{r} )}_{D} \approx κ ( \frac{{N}_{D} {m}_{e}}{{S}_{FWD} {d}_{e}} ) G {R}_{g} \cdot {t}_{D} {f}_{D} . \qquad ( Equation 8 )$$

As acceleration will not be produce without time dilation and retardation, a time dilation and retardation factor φ→1 must be added, where the factor φ approaches one (1) to infer that the electron density approaches 100% time dilated and retarded for the accelerated masses density.

Whereby for an the accelerated mass of mass mᵣ, the total thrust is given as

T≈mᵣ[(aᵣ)_{D}φ_{D}+(aᵣ)_{I}φ_{I}], (Equation 9)

where

T=T_{FWD}→mᵣ(aᵣ)_{D}φ_{D} (Equation 10)

for FWD motion t_{D} «t_{I} (slow increase, fast decrease) with φ_{D} »φ_{I}≈0 or

T=T_{AFT}→mᵣ(aᵣ)_{I}φ_{I} (Equation 11)

for AFT motion t_{I}«t_{D}, (fast increase, slow decrease) with φ_{I}»φ_{D}≈0, where the frequencies f_{I}=f_{D} as the increase and decrease of the electrons is assumed to occur one after the other.

These thrust equations apply whether the voltage charge is initially increases or decreases, to change the electron density on the surface of the accelerated mass. Further, the time dilation and retardation factor φ will be related to the times t_{I} or t_{D}, and may change from one design of an accelerated mass to another, due to such things as surface material composition, shape, external influences, etc. As such, a new Meta-material may be required to insure the occurrence of time dilation and retardation.

### SUMMARY

The present invention is directed to a method for creating asymmetric electron surface densities that change fast enough to produce time dilation and retardation between the density of the accelerated mass and the rapidly changing electron densities on the surface of the accelerated mass; to produce acceleration per a new quantum gravity model. The method includes, an accelerated mass, a pulse electric discharge system, a reversal means, and a controller.

The surface of the accelerated mass is composed of an electrically conductive material. The accelerated mass's shape is asymmetric to produce an asymmetric surface area in the plane of motion (FWD to AFT). The outer surface can also be laminated to add other features to the outer surface, as shape changing materials to produce asymmetric surface areas on demand.

The pulse electric discharge system provides a rapid voltage charge fast enough to produce time dilation and retardation between the density of the accelerated mass and the rapidly changing electron surface densities on the surface of the accelerated mass; initially and periodically thereafter at some frequency.

The reversal means causes the time it takes to reverse, the increase to decrease or the decrease to increase, the electron charge on the surface of the accelerated mass, caused by the pulse electric discharge system, to be slower than the time it took to increase or decrease the surface electron charge on the accelerated mass, caused by the pulse electric discharge system; to produce an asymmetry between these times to cause a net acceleration on the accelerated mass. Specially the time, it takes to reverse the increase or decrease of the electrons from the surface of the accelerated mass, should cause no or little time dilation and retardation between the density of the accelerated mass and the changing electron densities on the surface of the accelerated mass.

It is common knowledge that switches are used to reverse (charge or discharge) the electrons from the surface of objects, where there are many different types of switches known. That is, a switch can be a material (e.g., leaky dielectric), or any circuitry providing the same. It is further common knowledge that an increase or decrease of the electrons on the surface of objects causes an electron density change on the surface of objects.

Since the purpose of the reversal means is to slowly decrease or increase the electrons from the surface of the accelerated mass, it acts like a slow switch. Whereby, the reversal means refers to a material, or any circuitry that can provide slower electron flow (discharge) than during the reverse—the rapid increase or decrease of electron charge on the surface of the accelerated mass caused by the pulse electric discharge system. As such, to produce an asymmetric manner (rapidly to slowly or slowly to rapidly) increase or decrease of surface electron density.

The controller is needed between the electric discharge system and the reversal means to cause both to operate in consecutive order, one after the other, such that their frequency of operations is the same.

Other embodiments of the present invention are possible and discussed herein.

It is a feature of the present invention to provide a method for creating rapidly changing asymmetric electron surface densities for acceleration without mass ejection, using a new quantum gravity model.

### DRAWINGS

FIG. 1 shows a block diagram of a first embodiment of the present invention to illustrate the main function of the method.

FIG. 2 shows an illustration of the direction of motions of the accelerated mass due to the asymmetric ESQFs about the accelerated mass caused by operation of the method. FIG. 2A shows the motion of the accelerated mass in the FWD direction and FIG. 2B shows the motion of the accelerated mass in the AFT direction.

FIG. 3 shows a block diagram of a second embodiment of the present invention to illustrate the method when the reversal means is a leaky conductive material, laminated with the conductive surface of the accelerated mass.

FIG. 4 shows an illustration of the reversal means as a leaky conductive material laminated with the conductive surface of the accelerated mass.

FIG. 5 shows a block diagram of a third embodiment of the present invention to illustrate the method when a shape changing material is laminated with the conductive surface of the accelerated mass.

FIG. 6 shows an illustration of the shape changing material laminated with the conductive surface of the accelerated mass.

FIG. 7 shows a block diagram of the methods in FIGS. 1, 3, and 5 integrated into a single unit and placed inside the accelerated mass.

FIG. 8 shows the block diagrams of the integrated methods from FIGS. 1, 3, and 5. FIG. 8a shows the integrated methods from FIGS. 1, and 5. FIG. 8b shows the integrated methods from FIG. 3.

### DESCRIPTION

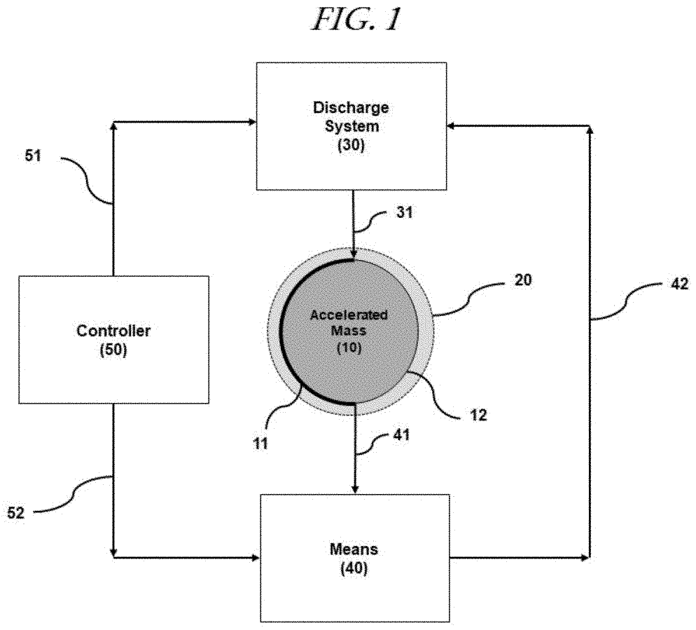

The preferred embodiments of the present invention are illustrated by way of example below and in FIGS. 1-8. In reference to the online peer reviewed paper by the inventor entitled “Quantum Gravity as a Quantum Warp Field,” on Research Gate, the General Science Journal, and LinkedIn websites, about the accelerator mass 10, in FIGS. 1, 3, 5 and 7, is an energy shell of quantum energy fluctuations (ESQFs) 20 that is equally distributed about the accelerator mass 10, when not accelerated (gravitationally or by other methods) having a thickness equivalent to the wavelength of the energy in the ESQFs. It is understood that the ESQFs 20 about the accelerator mass 10 has an outer radius that is only slightly greater than the radius of the accelerator mass 10, where the ESQFs 20 in FIGS. 1, 3, 5 and 7 are greatly exaggerated to enhance understanding.

Referring to FIG. 1, where FIG. 1 is a block diagram of the present invention containing a first embodiment of an accelerator mass 10 with ESQFs 20, a pulse electric discharge system 30, an reversal means 40, and a controller 50.

With reference to FIG. 1, the accelerator mass 10 has an outer surface area 11 larger than the outer surface area 12 to produce an asymmetric surface area about the accelerator mass 10. The outer surface areas 11 and 12 are electrically conductive. It is understood that the design of the asymmetric surface area about the accelerator mass 10 can be produced in many ways without taking from the intent of the present invention. For example, the surface area 12 can be smooth and the surface area 11 textured, i.e., textured like decorative sheet metal, sharkskin, or a completely new surface texture that greatly increases the surface area 11 over the surface area 12. Further, it is understood that the that the circular design of the accelerator mass 10 in FIG. 1 is arbitrary, as any shape of the accelerator mass 10 that produces an asymmetric surface area can be used without taking from the intent of the present invention. Still further, it is understood that the outer electrically conductive surface areas 11 and 12 could be of any conductive material, to include any natural or manmade conductive materials, and also include conductive gases, plasmas, superconductive materials, or other forms of conductive materials yet to be invented, like a Meta-material, without taken from the intend of this present invention.

With reference to FIG. 1, the pulse electric discharge system 30 is a circuit to produce a pulsed (rapid) voltage electrical discharge through conductor wire 31 to the surface areas 11 and 12 on the accelerator mass 10. The pulse electric discharge system 30 can either cause the electrons on the surface areas 11 and 12 to initially increase or decrease dependent on the initially wanted direction of motion. It is understood that there are many types of pulse electric discharge systems 30 patented and in literature. Therefore, the only challenge will be selecting one that can provide a rapid discharge to the surface of the accelerated mass 10. Further, it is understood the voltage can be high or low provide the rapid discharge creates a time dilated and retarded electron density. The preferred voltage is high. For example, the high voltage pulse electric discharge system designs of Tesla are many Many of which have been improved upon since their development by Tesla. Also high voltage Tesla coils and flybacks systems are very easy to build, even by amateur hobbyist. It is understood that the desired pulse electric discharge system 30 could have a simple or very complex pulsing circuit; or one yet to be designed without taken from the intend of this present invention.

With reference to FIG. 1, the rapidly increasing or decreasing electrons to the surface areas 11 and 12 of the accelerator mass 10 from the pulse electric discharge system 30 will reach a peak number of increased or decreased electrons. At this condition, the acceleration cause will stop. As such an reversal means 40 to bring the charged surface areas 11 and 12 on the accelerator mass 10 back to a an uncharged state by removing or increasing electrons through conductor wire 41 to return conductor wire 42 is needed before another increase or decrease electron cycle can start from the pulse electric discharge system 30. The reversal means 40 must increase or decrease the electrons on the surface areas 11 and 12 at a much slower time than the pulsed discharge time of the pulse electric discharge system 30 or the net acceleration on the accelerator mass 10 could be zero, per Equation 9. The return conductor wire 42 of the electron is taken to be back to the pulse electric discharge system 30. It is understood that the return conductor wire 42 could simply be to the ground of the pulse electric discharge system 30. Further, it is understood that the reversal means 40 can be very simple or very complex without taken from the intend of this present invention. For example, a properly placed resistor and switching circuit can simply be the reversal means 40. However, a more complex circuitry reversal means 40 could also be used in the present invention.

With reference to FIG. 1, the controller 50 is needed between the pulse electric discharge system 30 and the reversal means 40 to control their timing. In FIG. 1, the control line 51 is from the controller 50 to the pulse electric discharge system 30 to control the timing of the pulsed (rapid) voltage electrical discharge to the surface areas 11 and 12 on the accelerator mass 10 and the control line 52 is from the controller 50 to the reversal means 40 to control the timing of the removal of the increased electron or to control the timing to add the decreased electrons as needed before another increase or decrease electron cycle can start from the pulse electric discharge system 30. The pulse electric discharge system 30 and reversal means 40 have means, as a simple switch or switch circuitry, to accept the control signals from the controller 50. The controller 50 sends the control signal consecutively, one after the other, and at the same frequency of occurrence.

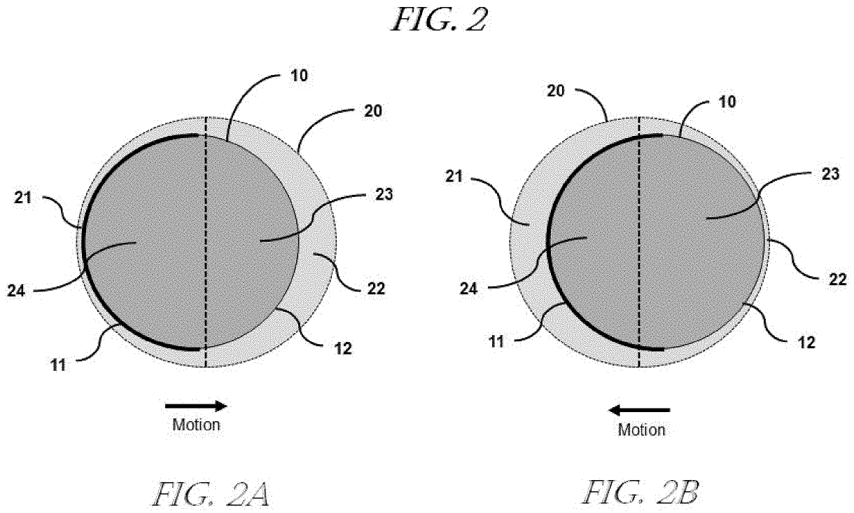

With reference to FIG. 2, FIG. 2A illustrates the case where the electron density on the surface areas 11 and 12 is rapidly decreasing (Equation 10) and FIG. 2B illustrates the case where the electron density on the surface areas 11 and 12 is rapidly increasing (Equation 11). It is understood that the pulse electric discharge system 30 can provided a voltage charge that increases the electron density on the surface areas 11 and 12 or provided a voltage charge that decreases the electron density on the surface areas 11 and 12. Further, it is understood that the reversal means 40 can decrease the electron density on the surface areas 11 and 12, when the surface areas 11 and 12 has an increased electron density or increase the electron density on the surface areas 11 and 12, when the surface areas 11 and 12 has a decreased the electron density.

With reference to FIG. 2A, the accelerated mass 10 is surrounded by an ESQFs 20 that has shifted about the center of the accelerated mass 10 to produce a small thickness 21 and a larger thickness 22 that represents the change in the quantum energy about the accelerated mass 10 due to the change in the electron densities on the surface areas 11 and 12; which produces a reallocation of the mass of the accelerated mass 10 about the ESQFs 20 outer radius (dotted vertical line) causing an asymmetry in the mass density distribution within the ESQFs 20 outer radius. In FIG. 2A, the AFT mass portion 24 is greater than the FWD mass portion 23, within the ESQFs 20 to cause FWD acceleration, per Equation 10.

With reference to FIG. 2B, the accelerated mass 10 is surrounded by an ESQFs 20 that has shifted about the center of the accelerated mass 10 to produce a small thickness 22 and a larger thickness 21 that represents the change in the quantum energy about the accelerated mass 10 due to the change in the electron densities on the surface areas 11 and 12; which produces a reallocation of the mass of the accelerated mass 10 about the ESQFs 20 outer radius (dotted vertical line) causing an asymmetry in the mass density distribution within the ESQFs 20 outer radius. In FIG. 2B, the FWD mass portion 23 is greater than the AFT mass portion 24, within the ESQFs 20 to cause AFT acceleration, per Equation 11.

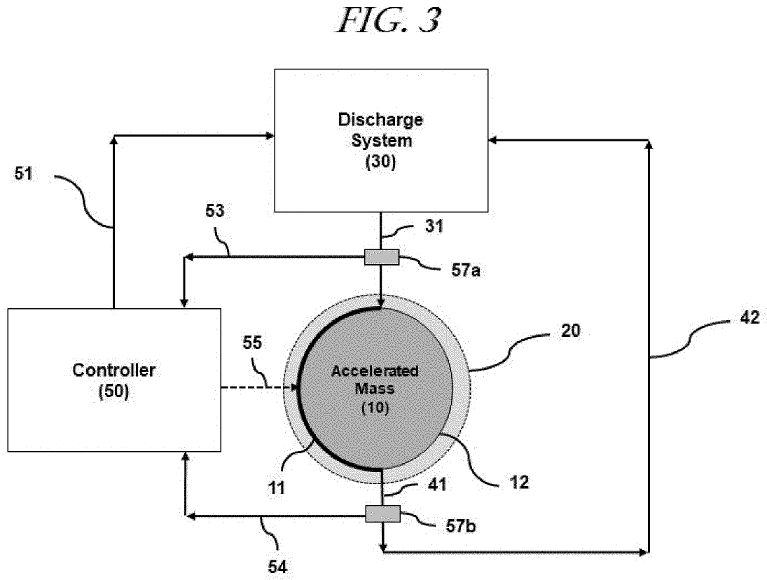

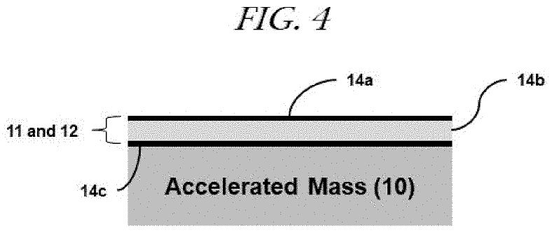

With reference to FIG. 3, where FIG. 3 is a block diagram of the present invention containing another embodiment of an accelerator mass 10 with ESQFs 20, a pulse electric discharge system 30, and a controller 50. The accelerator mass 10 is the same as described in FIG. 1 except the surface area about the accelerator mass 10 is laminated as shown in FIG. 4. The pulse electric discharge system 30 is the same as described for FIG. 1.

With reference to FIG. 3, the controller 50 only provides the timing for the pulse electric discharge system 30 by using sensor 57a to monitor the current through conductor wire 31 from the pulse electric discharge system 30 and sensor 57b to monitor the low current through conductor wire 41 to conductor wire 42. Specifically, the controller 50 sends a control signal through signal line 51 to the discharge system 30; detects the current flow though conductor wire 31 with sensor 57a to determine that the voltage pulse was sent; detects the low current flow though conductor wire 41 with sensor 57b to determine that the electrons density on the surfaces 11 and 12 have reversed state (increase or decrease), to determine when to send the next control signal through signal line 51 to the pulse electric discharge system 30. It is understood that the timing between the currents though conductor wires 31 and 41 may not always be the same, whereby the frequency of the control signal through signal line 51 to the pulse electric discharge system 30 may not be as regular as in FIG. 1.

With reference to FIGS. 3 and 4, the surface areas 11 and 12 are asymmetric as descried in FIG. 1, comprising a lamination of an outer conductive surface 14a, a leaky conductive material 14b, and conductor material 14c. The a leaky conductive material 14b provides the reversal means 40. The conductor material 14c is connected to the conductor wire 41. It is understood that the leaky conductive material 11c will not allow the electrons deposited on the outer conductive surface 14a of surfaces 11 and 12 through to the conductor material 14c until some condition has been met. For examples, the leaky conductive material 14a could be composed of a material that will not let AC (time varying) current pass through it or will not let current pass through it until a bias current or voltage applied in a specific manner from the controller 50 through control line 55, as with transistors, Mosfet, and similar devices; or some method or material not yet known to the inventor or invented, as a Meta-material. In each case allowing the surface electrons to slowly increase or decrease only after a steady state charge condition has been met.

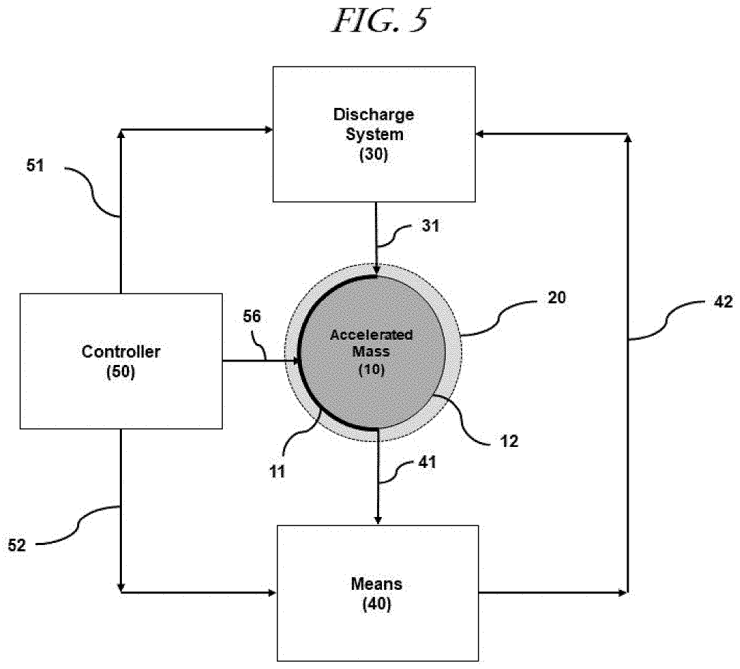

With reference to FIG. 5, where FIG. 5 is a block diagram of the present invention containing second embodiment of an accelerator mass 10 with ESQFs 20, a pulse electric discharge system 30, reversal means 40, and a controller 50. The a pulse electric discharge system 30, reversal means 40 is the same as described for FIG. 1.

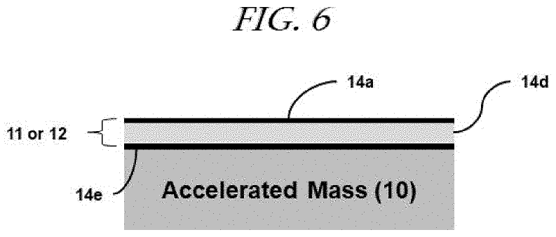

With reference to FIGS. 5 and 6, the surface areas 11 and 12 are asymmetric as described in FIG. 1 comprising a lamination of an outer conductive surface 14a, shape changing material 14d and control method 14e. The control method 14e is connected to control line 56, and is a representation of the means to control the shape changing material 14d; an example method could simply be the application of an electrical current or voltage potential. It is understood that the means to control the shape changing material 14d may need to be electrically isolated from the outer conductive surface 14a. Further, it understood that the conductive surface 14a may be symbiotic with the shape changing material 14d. Still further it is understood that the conductive surface 14a must be designed to freely move with the shape changing material 14d. Even further the shape changing material 14d and control method 14e may only need to be applied to either surface area 11 or 12.

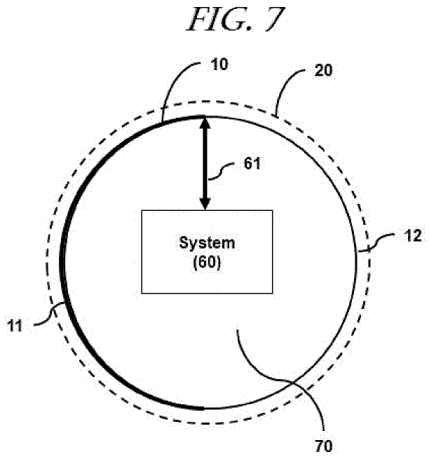

With reference to FIG. 7, where FIG. 7 is third embodiment of the present invention containing an accelerator mass 10 with ESQFs 20 that has a cavity 70 to house, a system 60, and conductive wires 61. The surface areas 11 and 12 of the accelerator mass 10 are asymmetric as described in FIG. 1. The surface varies with reference to FIGS. 1, 3, or 5 with respect to FIGS. 2, 4, or 6.

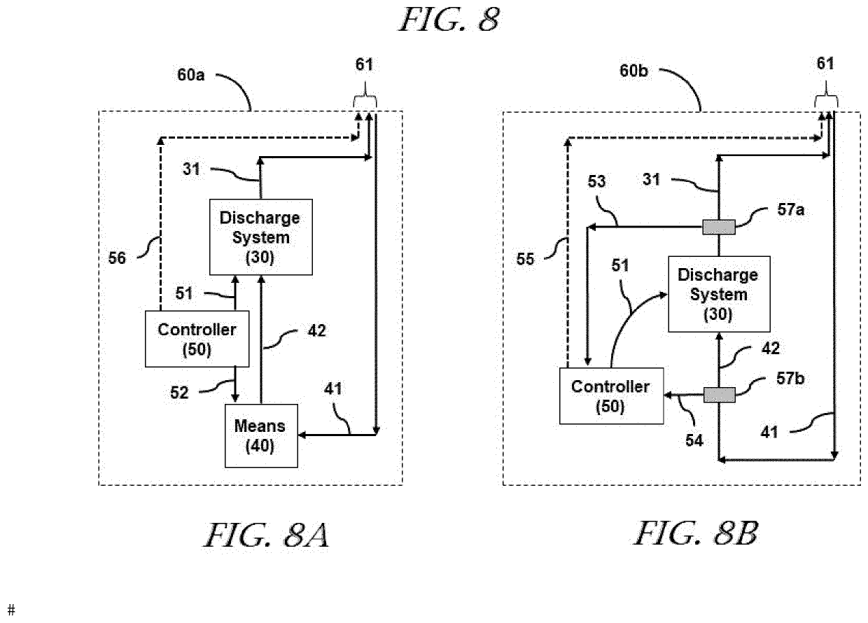

With reference to FIGS. 7 and 8, FIG. 8 is the embodiments of system 60. In FIG. 8a, system 60a contains the pulse electric discharge system 30 with conductor wire 31, the reversal means 40 with conductor wire 41, and a controller 50 with signal lines 51, 52, and 56 in FIGS. 1 and 5. The signal line 56 is dashed in FIG. 8a to indicate the difference between FIG. 1 and FIG. 3. The operation of system 60a is the same as in FIG. 1 or FIG. 5. In FIG. 8a, the conductive wires 61 contains the conductor wire 31, conductor wire 41, and the signal line 56 when the embodiments in FIG. 5 are used. In FIG. 8b, system 60b contains the pulse electric discharge system 30 with conductor wire 31, and a controller 50 with signal lines 51, 53, 54 and 55 and sensors 57a and 57b in FIG. 3. The signal line 55 is dashed in FIG. 8b to indicate that there are difference options on how the reversal means 40 can be controlled. The operation of system 60b is the same as in FIG. 3. In FIG. 8b, the conductive wires 61 contains the conductor wire 31, conductor wire 41, and signal line 55.

What is claimed is:

1. A method for creating asymmetric electron surface densities for acceleration without mass ejection comprising:
an accelerated mass, having an outer asymmetric conductive surface in the plane of motion;
an energy shell of quantum fluctuations (ESQFs) about said outer asymmetric conductive surface;
a pulse electric discharge system to provide a rapid positive or negative voltage charge to said asymmetric conductive surface of said accelerated mass, where a positive voltage charge decreases the surface electron density and a negative voltage charge increases the surface electron density on said asymmetric conductive surface of said accelerated mass;
a reversal means, to slowly reverse (decrease or increase) the surface electron charge on said asymmetric conductive surface of said accelerated mass, provided by the pulse electric discharge system, to slowly decrease or increase the surface electron density on said asymmetric conductive surface of said accelerated mass, and
a controller to control the timing of said pulse electric discharge system and said reversal means; and
when said controller sends a signal to said pulse electric discharge system, said pulse electric discharge system sends said rapid voltage charge to said asymmetric conductive surface of said accelerated mass to establish a rapidly increasing or decreasing electron density on said asymmetric conductive surface of said accelerated mass that produces a first time dilated and retarded electron density from the density of said accelerated mass, where said asymmetric conductive surface of said accelerated mass produces an asymmetric electron density on said accelerated mass to cause said energy shell of quantum fluctuations (ESQFs) about said accelerated mass to become asymmetric to cause a first acceleration on said accelerated mass during the rapid electron density change, to provide rapid motion in a first direction;
when the end of said rapid voltage charge has been reached, said controller sends a signal to said reversal means to reverse (decrease or increase) the surface electron charge on said asymmetric conductive surface of said accelerated mass, to establish a slow decreasing or increasing of the surface electron density on said asymmetric conductive surface of said accelerated mass that produces a much lower second time dilated and retarded electron density from the density of said accelerated mass, to produce a smaller second acceleration on said accelerated mass, to provide a slower motion in a second direction opposite to said first direction;
when the end of said slow reversal (decrease or increase) of said surface electron density has been reached, said controller sends a signal to said pulse electric discharge system to start another cycle, over and over;
thus to produce a net acceleration method (said first acceleration in said first direction plus said second acceleration in said second direction) without mass ejection.

2. The method of claim 1, wherein said rapid voltage charge from said pulse electric discharge system establishes a rapidly increasing electron density on said asymmetric conductive surface of said accelerated mass to cause said first acceleration to be in a said first direction in said plane of motion.

3. The method of claim 1, wherein said rapid voltage charge from said pulse electric discharge system establishes a rapidly decreasing electron density on said asymmetric conductive surface of said accelerated mass to cause said first acceleration to be in a said direction in said plane of motion.

4. The method of claim 1, wherein said asymmetric conductive surface of said accelerated mass is a conductive gas.

5. The method of claim 1, wherein said asymmetric conductive surface of said accelerated mass is a plasma.

6. The method of claim 1, wherein said asymmetric conductive surface of said accelerated mass is a superconductive material.

7. The method of claim 1, wherein said asymmetric conductive surface of said accelerated mass is a Meta-material.

8. The method of claim 1, wherein said asymmetric conductive surface of said accelerated mass is shape changing, controlled by said controller to produce the asymmetry of said asymmetric conductive surface in said plane of motion.

9. The method of claim 1, wherein said pulse electric discharge system, said reversal means, and said controller is inside said accelerated mass.

10. A method for creating asymmetric electron surface densities for acceleration without mass ejection comprising:
an accelerated mass, having an outer asymmetric conductive surface in the plane of motion;
an energy shell of quantum fluctuations (ESQFs) about said outer asymmetric conductive surface;
a pulse electric discharge system to provide a rapid positive or negative voltage charge to said asymmetric conductive surface of said accelerated mass, where a positive voltage charge decreases the surface electron density and a negative voltage charge increases the surface electron density on said asymmetric conductive surface of said accelerated mass;
an reversal means laminated under said asymmetric conductive surface to slowly reverse (decrease or increase) the surface electron charge on said asymmetric conductive surface of said accelerated mass, provided by the pulse electric discharge system, to slowly decrease or increase the surface electron density on said asymmetric conductive surface of said accelerated mass, and
a first and second current sensor, said first sensor senses the current from said voltage charge to said asymmetric conductive surface of said accelerated mass and said second sensor senses the reversal (decrease charge or increase charge) current from said asymmetric conductive surface of said accelerated mass through said reversal means back to said pulse electric discharge system; and
a controller to accept the input signals from the first and second current sensor and control the timing of said pulse electric discharge system; and
when said controller sends a signal to said pulse electric discharge system, said pulse electric discharge system sends said rapid voltage charge to said asymmetric conductive surface of said accelerated mass; producing a current through said first sensor, which is report to said controller; said current establishes a rapidly increasing or decreasing electron density on said asymmetric conductive surface of said accelerated mass that produces a first time dilated and retarded electron density from the density of said accelerated mass, where said asymmetric conductive surface of said accelerated mass produces an asymmetric electron density on said accelerated mass to cause said energy shell of quantum fluctuations (ESQFs) about said accelerated mass to become asymmetric to cause a first acceleration on said accelerated mass during the rapid density change, to provide rapid motion in a first direction;
when the first sensor reports to said controller that the end of said rapid voltage charge has been reached, said reversal means produces a low current through said second sensor, which is report to said controller; said slow current establishes a slow decreasing or increasing of the surface electron density on said asymmetric conductive surface of said accelerated mass, that produces a much lower second said time dilated and retardation from the density of said accelerated mass, to produce a smaller second acceleration on said accelerated mass, to provide slow motion in a second direction;
when the second sensor reports to said controller that the end of said low current has been reached, the said controller sends a signal to said pulse electric discharge system to start another cycle, over and over;
thus to produce a net acceleration method (said first acceleration in said first direction plus said second acceleration in said second direction) without mass ejection.

11. The method of claim 10, wherein said rapid voltage charge from said pulse electric discharge system establishes a rapidly increasing electron density on said asymmetric conductive surface of said accelerated mass to cause said first acceleration to be in a said first direction in said plane of motion.

12. The method of claim 10, wherein said rapid voltage charge from said pulse electric discharge system establishes a rapidly decreasing electron density on said asymmetric conductive surface of said accelerated mass to cause said first acceleration to be in a said second direction in said plane of motion.

13. The method of claim 10, wherein said reversal means laminated under said asymmetric conductive surface is a material that does not allow the time-varying electrons, provide by the rapid voltage charge, to pass through it.

14. The method of claim 10, wherein said asymmetric conductive surface of said accelerated mass is a superconductive material.

15. The method of claim 10, wherein said reversal means laminated under said asymmetric conductive surface is a Meta-material.

16. The method of claim 10, wherein said reversal means laminated under said asymmetric conductive surface is a material that does not allow electrons to pass through it until said controller sends a control signal to said reversal means.

17. The method of claim 10, wherein said asymmetric conductive surface of said accelerated mass is shape changing, controlled by said controller to produce the asymmetry of said asymmetric conductive surface in said plane of motion.

18. The method of claim 10, wherein said pulse electric discharge system, said reversal means, and said controller is inside said accelerated mass.
